(19) United States
(12) Patent Application Publication
(10) Pub. No.: US 2021/0158398 A1
(43) Pub. Date: May 27, 2021

(54) USER DATA SEGMENTATION AUGMENTED WITH PUBLIC EVENT STREAMS FOR FACILITATING CUSTOMIZATION OF ONLINE CONTENT

(71) Applicant: Adobe Inc., San Jose, CA (US)

(72) Inventors: Roy Merrill, Orem, UT (US); Shravanthi Manohar, Lehi, UT (US); Ryan Baarz, Lehi, UT (US); Kelly Nicholes, Lehi, UT (US); Gabriel Rodriguez, Saratoga Springs, UT (US); Brian Bishop, Lehi, UT (US); Anuj Jain, Draper, UT (US)

(21) Appl. No.: 16/691,221

(22) Filed: Nov. 21, 2019

(51) Int. Cl. G06Q 30/02; G06N 20/00

(52) U.S. Cl. CPC G06Q 30/0269; G06Q 30/0252; H04W 4/14; G06Q 30/0277; G06N 20/00; G06Q 30/0254

(57) ABSTRACT

Techniques are described herein for intelligently identifying and creating user segments based on public data attributes in addition to user data attributes. In certain embodiments, a data analytics platform is disclosed that receives user data associated with users and public event streams from public data sources. The data analytics platform selects a set of public event categories associated with the public event streams to display in a segment builder application for generating user segments associated with the users. The data analytics platform outputs the set of public event categories and the user data associated with the users to enable a user of the segment builder application to generate the user segments based on the user data and the set of one or more public event categories.

### TECHNICAL FIELD

The present disclosure relates generally to automated data analysis and user segmentation techniques. More specifically, but not by way of limitation, this disclosure describes automated techniques for using public event streams accessible via public networks to augment user segmentation and, in some cases, thereby facilitate the customization of online content presented to user devices.

### BACKGROUND

Automated modeling applications involve building and training models to generate predictions or other analytical outputs from an input dataset, such as a set of user attributes (i.e., a user segment) or other attributes. Building these models often involves using software tools for defining segments, which could involve identifying the attributes and ranges of attribute values included in a segment. For instance, identifying groups of users, commonly referred to as user segmentation, is used for many reasons, such as for customization of online content, improved targeting of electronic services, and others. User segmentation involves analyzing captured user data, such as data related to users' online activities (e.g., navigation to certain websites, interaction with certain website features, etc.), to divide users into distinct groups, or segments, with different characteristics. User segments generated using user segmentation techniques can be used for various purposes, such as to customize online information that is targeted to a user based upon the segment to which the user belongs. For example, an online content provider system could modify how a website or other user environment is presented to a given user device based on a segment to which a user of the user device is assigned. Examples of modifications include more prominently displaying user interface elements for user devices in a particular segment, tailoring content for a user device assigned to a particular segment, or transmitting website suggestions to devices in a particular segment.

But existing software tools for building segments have limited usefulness for helping a user integrate data from public streams with user data. For instance, existing software tools require a user to manually select different types of data that could be used to build a segment. These existing tools require the user to identify and select relevant attributes and attribute values that define the segment and to affirmatively instruct the software tool to retrieve data matching the segment definition. This manual process may provide acceptable results for cases in which the number of available data sources or datasets is small or if a user has detailed knowledge about which datasets should be used to build a user segment.

However, because existing software tools rely, for their effectiveness, on a user's detailed knowledge of which datasets and dataset attributes should be used to build a useful segment, the functions for manually defining user segments offered by existing tools present disadvantages. For instance, existing tools lack features that allow for simultaneously analyzing large numbers of public event streams. Requiring rapid decision making and manual input by the user makes it impossible for these tools to repeatedly search through different public event streams, identify the various attributes of the event streams, assess the relevance of a given public event stream to a model, and update a segment definition to incorporate the public event stream data into a segment. Furthermore, existing tools lack features for assisting users with avoiding public event data that appears relevant to a user while actually lacking a strong correlation with the user data being used to build segments. Existing software tools lack features that would allow a user to quickly and accurately identify relevant sources of data or datasets available from these sources for integration into a user segment. Therefore, existing software tools are not capable of effectively integrating user interaction data with a large volume of potentially relevant data from multiple event data sources when building segments used by automated modeling systems for generating predictions or other analytical outputs.

### SUMMARY

The present disclosure describes automated techniques for using public event streams accessible via public networks to augment user segmentation and, in some cases, thereby facilitate the customization of online environments presented to user devices. In certain embodiments, in addition to user data collected or owned by a company, public data available through networked online public data sources is also used for intelligently identifying and creating user segments. Segments can thus be created responsive to events received from such online public data sources where the user segments are generated using public data attributes of the public data events in addition to user data attributes from the user data.

In certain embodiments, a segment builder application is disclosed that accesses user data generated by interactions with online content by user devices and a set of public event streams accessible from remote data sources. Each public event stream described events independent of the interactions with the online content. The segment builder application receives, via a segment-definition interface of the segment builder application, a recommendation request for identifying public event stream data for integration with the user data. In certain embodiments, responsive to the recommendation request, the segment builder application executes an integration algorithm configured for correlating attributes from the user data with attributes of the public event stream. The segment builder application selects a public event stream that is correlated with one or more of the attributes from the user data and updates the segment-definition interface with a recommendation identifying a set of attributes from the public event stream having a correlation with the one or more of the attributes from the user data.

In certain embodiments, the segment builder application receives a command from the user to generate or modify a target user segment with the public event stream and the set of attributes from the public event stream. The segment builder application updates the target user segment to integrate data from the public event stream having the set of attributes, wherein updating the target user segment causes customized online content associated with the target user segment to be presented to a target user device.

In certain embodiments, the data analytics platform is configured to receive information related to a user segment. The user segment comprises an expression comprising conditions based on the user data associated with the users. The data analytics platform identifies a user segment category associated with the user segment that matches a public event category associated with a public event stream. The data analytics platform outputs information identifying the user segment, information identifying the public event category associated with the public event stream and information identifying a correlation between the user segment and the public event category to a user of the platform. In certain examples, the data analytics platform uses the outputted information for customizing online content presented to a user device.

In certain embodiments, the data analytics platform is configured to identify that a public event category associated with a public event stream matches a user data category associated with the user data. The data analytics platform then identifies an expression for defining a new user segment. The expression comprises a first condition based on an attribute of a public event type associated with the public event category and a second condition based on a user attribute associated with the user data. The data analytics platform outputs information related to the new user segment to a user. In certain examples, the data analytics platform uses the outputted information for customizing online content presented to a user device

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is a block diagram depicting an example of a computing system including a data analytics platform, according to certain embodiments;

FIG. 2 depicts an example of a process for identifying and selecting public event types and public event categories to output to a customer of the platform according to certain embodiments;

FIG. 3 depicts an example of a process for selecting public event types and public event categories according to certain embodiments;

FIG. 4 is an example of a user interface (UI) that may be utilized to create user segment expressions, according to some embodiments;

FIG. 5 depicts an example of a process for enhancing a previously defined user segment using certain selected public event categories and public event types according to certain embodiments;

FIG. 6 is an example of an alert that is output to a customer of the platform, according to some embodiments;

FIG. 7 depicts an example of a process for identifying a new user segment according to certain embodiments;

FIG. 8 is an example of an alert that is output to a customer of the platform 100, according to some embodiments;

FIG. 9 depicts an example of a computing system for implementing certain embodiments of the present disclosure; and

FIG. 10 depicts an example of a cloud computing system for implementing certain embodiments of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure involves automated techniques for using public event streams accessible via public networks to augment user segmentation and, in some cases, thereby facilitate the customization of online environments presented to user devices. For instance, in addition to user data collected or owned by a company, public data available through networked online public data sources is also used for intelligently identifying and creating user segments. Segments can thus be created responsive to events received from such online public data sources where the user segments are generated using public data attributes of the public data events in addition to user data attributes from the user data. This enables suggestion and creation of user segments that are more appropriate for customizing online content for presentation to certain user devices (e.g., by presenting customized content with which users are more likely to interact).

The following non-limiting example is used to introduce certain embodiments. In this example, a segment builder application is executed on a computing system and assists a user with updating existing user segments, building new user segments, or both. For instance, user segments can be defined to include user data that is generated by interactions with online content by user devices. The segment builder application includes functions for suggesting public event stream data that would be useful to include in the segment definition. The public event streams, which are accessible via public networks, include data that describes certain events (e.g., weather event data, stock event data, news event data, and the like) that are independent of the user interactions and attributes described by user data. For instance, the event data in a public data stream may not be generated (at least directly) by the interactions of individual users with websites or other online services. The public data received via these public event streams may include real time data related to events that have recently happened, are currently happening, or are about to happen in the near future.

To assist a user with integrating this public event stream data, the segment builder application presents a segment-definition interface to an end user. The segment-definition interface includes various functions for identifying the datasets and attributes that will be used to build a segment. These functions include a recommendation request tool (e.g., a menu element, a prompt to a user, etc.), which is used to automatically identify, from a set of public event streams accessible to the segment builder application public event stream data for integration with the user data. Responsive to receiving such a recommendation request via the segment-definition interface, the segment builder application executes an integration algorithm configured for correlating attributes from the user data with attributes of the public event stream. One example of an integration algorithm is a machine-learning model that has been trained to recognize associations between attributes found in user data and attributes found in public event stream data. Another example of an integration algorithm is a model that has learned to recognize the type of event data that a user of the segment builder application frequently selects and that uses that learned pattern to focus on public event streams that are more relevant to the user. Another example of an integration algorithm is a set of association rules (e.g., in the form of if-then-else rules) that map user segment categories associated with user segments to public event categories associated with public event streams. By executing the integration algorithm, the segment builder application selects, from a set of different public event streams, one or more particular public event streams having event data that is correlated with or otherwise relevant to one or more of the attributes from the user data.

The segment builder application subsequently updates the segment-definition interface with a recommendation identifying a set of attributes from the public event stream having a correlation with the one or more of the attributes from the user data. For example, the recommendation could indicate that certain attributes should be included in the definition of a user segment. The recommendation can prompt the user to enter a command to generate or modify a target user segment with the public event stream and the set of attributes from the public event stream (e.g., by dragging and dropping the identified attributes from the public event stream into a segment definition pane). The segment builder updates a target user segment to integrate data from the public event stream having the set of attributes. In some cases, online content associated can be then customized according to the target user segment for presentation to one or more target user devices.

Certain embodiments described herein address deficiencies of existing segment-building tools with respect to integrating public event data into user data. For example, the integration algorithm discussed above facilitates automatically finding and selecting public event streams that are more relevant to a user of a segment-building tool, more suitable for the user attribute data, or both. The integration algorithm is triggered via a suitable command (e.g., a one-click request) in a segment definition interface of the segment building tool. In this manner, complexities of analyzing a large number of publicly available event streams, focusing on the most relevant streams, and presenting those streams to an end user for incorporation into a data segment are hidden from the user. Thus, the recommendation features discussed in the example above increase the utility of segment building tools by making these tools simpler and more intuitive to an end user.

As used herein, the term “user segment” is used to refer to a group or subset of users. A user segment is defined by one or more conditions or criteria associated with the user segment that a user may satisfy to be considered a member of the user segment. All the users in a user segment satisfy the particular one or more conditions or criteria that are associated with and define that user segment.

As used herein, the term “segment builder application” is used to refer to a tool that enables a user of a user device to create one or more user segments. As part of creating a user segment, the segment builder application enables a user of the application to specify one or more conditions or criteria to be associated with a user segment and defines which users can be considered as members of the user segment.

As used herein, the term “user data” refers to data that has been captured and stored for multiple users. For example, the user data may include data that has been captured and stored regarding users' online activities such as users visiting a website, users' online purchases, and the like.

As used herein, the term “public event stream” is used to refer to a stream of public events data received at periodic intervals from a public data source, where the public events data does not include any information that has been captured for a user and stored in the user data. The public events data received via a public event stream is received independent of the user data and is not received in response to or triggered by actions or activities performed by the users for whom the user data is collected.

As used herein, the term “public data source” is used to refer to a source of a public event stream, where the source is provided by a third party provider that is different from the entity capturing and storing the user data.

As used herein, the term “public event category” is used to refer to a category of information associated with public events data received via a public event stream. For example, a stream of public events data received from a “weather source” may be associated with a “weather” or a “winter” category.

As used herein, the term “user data category” is used to refer to a category of information associated with the user data and is determined based on a combination of one or more user attributes associated with the user data.

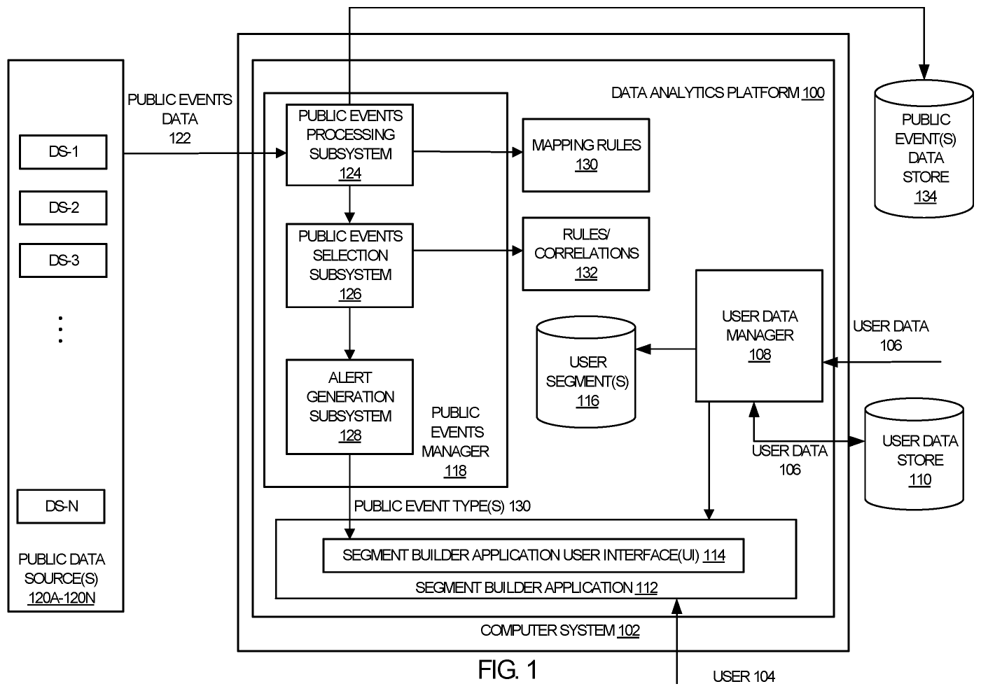

Referring now to the drawings, FIG. 1 is an example of a data analytics platform 100 that is implemented using a computer system 102 according to certain embodiments. In the embodiment depicted in FIG. 1, the data analytics platform 100 includes a number of systems and subsystems including a user data manager 108, a segment builder application 112, and a public events manager 118. These systems and subsystems may be implemented using software (e.g., code, instructions, program) executed by one or more processing units (e.g., processors, cores), hardware, or combinations thereof. The configuration depicted in FIG. 1 is merely an example and is not intended to unduly limit the scope of claimed embodiments. One of ordinary skill in the art would recognize many possible variations, alternatives, and modifications. For example, while the data analytics platform 100 shown as being implemented by a single computer system 102 in FIG. 1, in alternative embodiments it can be implemented by multiple computer systems communicatively coupled with one another. Additionally or alternatively, the systems and subsystems may operate separately, such as by operating as multiple applications on the computing system 102 or by operating as multiple applications on multiple computing systems. For example, in some implementations, data analytics platform 100 can be implemented using more or fewer systems and subsystems than those shown in FIG. 1, may combine two or more systems or subsystems, or may have a different configuration or arrangement of systems and subsystems. An example of segment builder application 112 is the Adobe Segment Builder®.

The data analytics platform 100 is configured to facilitate the creation of user segments. The data analytics platform 100 enables user segments to be generated using user data 106 and additionally based upon public events 122 received by the data analytics platform 100. The user data 106 may be received by the data analytics platform 100 and/or may be accessed by the data analytics platform 100 from the user data store 110 that stores the user data. The user data 106 may include user attributes and associated attribute values and user interaction data and associated user interaction values (examples provided below). Information related to user segments may be stored in data store 116. As described below in further detail, the data analytics platform 100 facilitates and enhances user segmentation by:

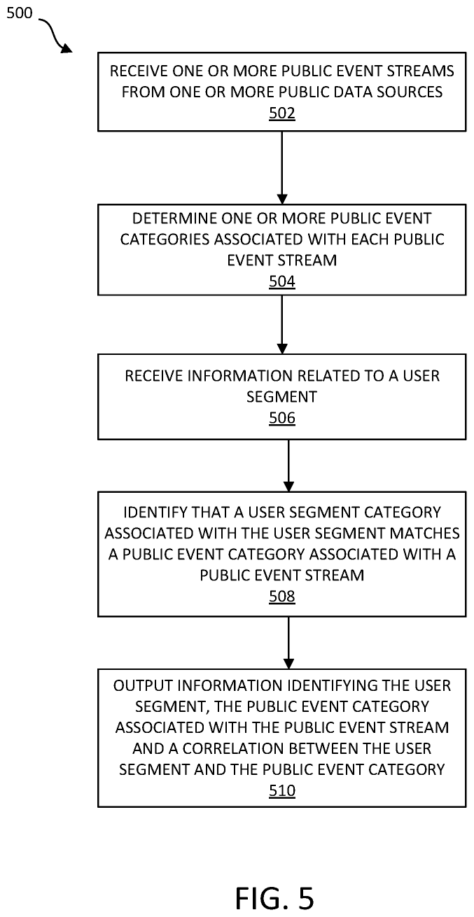

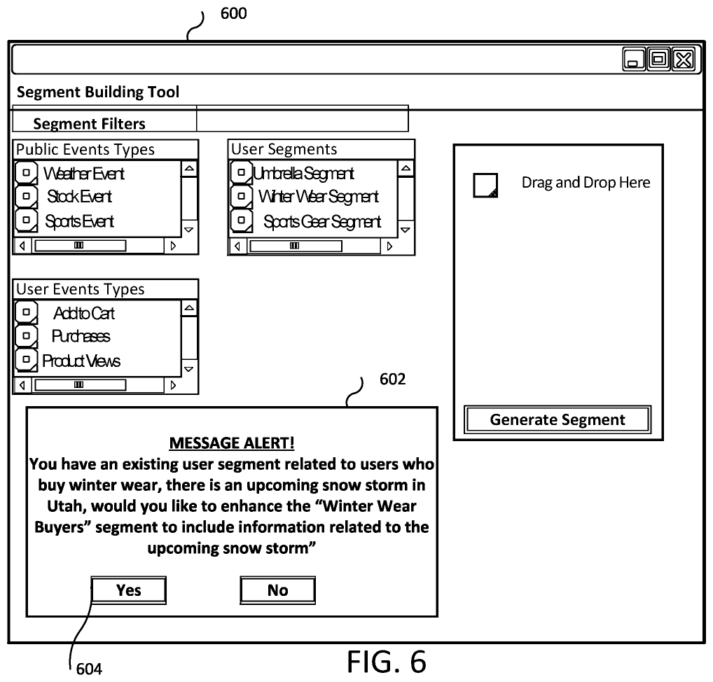

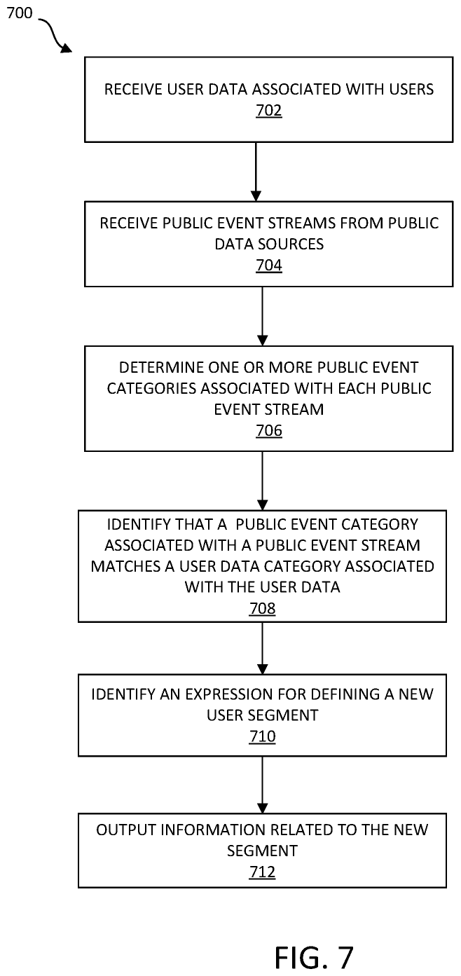

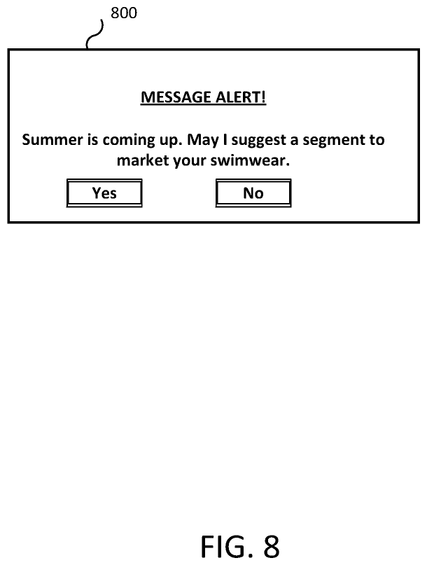

(a) Processing the public events 122 and identifying public event categories and public event types 130, which are then presented to a user (e.g., a marketer) via segment builder application 112 such that the user can, in addition to the user data, also use attributes of the public event types 130 to specify criteria for defining and creating user segments using the segment builder application 112. Details of the operations performed by the data analytics platform 100 to identify and select public event categories and public event types for defining and creating user segments is discussed in relation to FIGS. 1-4.
(b) Recommending ways for enhancing a previously defined user segment (e.g., a user segment previously defined using criteria based upon user data attributes) using certain selected public event categories and public event types. Details of the operations performed by the data analytics platform 100 to recommend ways for enhancing a previously defined user segment using selected public event categories and public event types is discussed in relation to FIGS. 5-6; and/or
(c) Recommending ways for creating a new focused user segment based upon attributes related to public event categories and public event types and attributes from the user data. Details of the operations performed by the data analytics platform 100 to recommend ways to create a new focused user segment using selected public event categories and public event types is discussed in relation to FIGS. 7-8. In certain examples, the data analytics platform causes customized online content associated with the user segment to be presented to a user device. The customized online content can include, for instance, customized web pages, specific online content such as targeted campaigns for specific products, etc. to users in that user segment. In certain examples, the customized online content is a web page with a layout, functionality, or both tailored to the characteristics of a given user segment and the characteristics of the public data used to augment the user segment.

As previously described, the data analytics platform 100 may receive the user data 106 or may access it from the user data store 110. The user data manager 108 is configured to process the user data 106. The user data 110 may be data captured by a company related to its users. For example, for a website provider, the user data 106 may be data collected for users that visit the website provider's web site or an application of the website provider. The user data may be received from one or more sources, external or internal to the platform 100. For example, a user may use the user's computing device (e.g., a mobile device, laptop, etc.) to access a website hosted by the website provider. The website may include code configured to monitor, track, and collect information related to the user's usage of interactions with the website. This collected information for the user, and for other users, may be transmitted to the data analytics platform 100 or may be stored in the user data store 110, from where the user data may then be made available to the platform 100. As another example, the user data received by the data analytics platform 100 may be received from a source, such as a social media system/network, that tracks user interactions and information related to these interactions may be provided to the platform 100.

The user data 106 can include various types of data in one or more different formats. The user data 106 typically includes attributes (user attributes) and user interactions and values associated with the user attributes and user interactions. For example, for a user interacting with a website, the user attributes and associated values may include name of the user, age of the user, location of the user, gender of the user, preferences of the user, and the like. The user interactions may include webpages or website links accessed by the user, actions taken by the user on a web page (e.g., a purchase of an item), products/services purchased by the user using the website, value of the purchases, clicks, products added to a virtual shopping cart, browsing information, and so on.

The user data manager 108 is configured to manage and process the user data 106. In certain embodiments, the user data manager 108 is configured to analyze the user data received by the data analytics platform 100, either directly or accessed from the user data store 110. For example, the user data manager 108 may process the user data and determine user events from the user data. The user data manager 108 may also determine one or more user data categories to be associated with portions of the user data. For instance, if the received user data comprises information related to a purchase made by the user on a website, then the user data manager 108 may associate a “purchase event” with that user data associated with the user. In a similar manner, the data manager 110 may associate a user data category with the user data associated with each user. For instance, if the user data indicates purchases of a particular type of item (e.g., snow gear) by a user, then the user data manager 108 may associate a “weather” data category (or multiple categories) with that user data. The user data category may be selected from a list of pre-configured data categories accessible to the user data manager 108.

In certain embodiments, the user data 106 and the results of processing performed by the user data manager 108 may be stored in a database in the user data store 110, where the database organizes the user data 106 into one or more tables. Table A shown below depicts an example table storing user data.

TABLE A
User Data table

| User | | | User | User Data |
|---|---|---|---|---|
| Id | User Data | | Event | Category |
| UId 1 | <attr#1 = value>, | <int#1 = value>, | Purchase | Weather/ |
| | <attr2#2 = value>, | <int2#2 = value>, | Event | Winter |
| | <attr3#3 = | <int3#3 = | | |
| | value> . . . | value> . . . | | |
| UId 2 | <attr#1 = value>, | <int#1 = value>, | Product | Winter |
| | <attr2#2 = value>, | <int2#2 = value>, | View | Wear/ |
| | <attr3#3 = | <int3#3 = | Event | Snow Gear |
| | value> . . . | value> . . . | | |
| UId 3 | <attr#1 = value>, | <int#1 = value>, | Add to | Weather/ |
| | <attr2#2 = value>, | <int2#2 = value>, | Cart | Swimwear |
| | <attr3#3 = | <int3#3 = | Event | |
| | value> . . . | value> . . . | | |

In the example table above, the user data table is organized into one or more columns including a user identifier (UId) column, a User Data column, a User Event column and a User Data Category column. The UId column uniquely identifies the user and/or the computing device utilized by the user while interacting with the website. The User Data column identifies one or more user attributes and one or more user interactions associated with each user. Examples of user attributes associated with a user may include, for instance, the user's age group, gender, location, preferences of the user and the like. Examples of user interactions may include website interactions by a user such as the number of links in a web page selected by the user, the number of web pages viewed by the user or actions taken by the user on a web page (e.g., a purchase of an item), information related to the action (e.g., item purchased, number of purchases, value of the purchases etc.), historic and/or current website browsing information for the user, and so on. The illustrated user data table is merely an example and is not intended to unduly limit the scope of claimed embodiments. One of ordinary skill in the art would recognize many possible variations, alternatives, and modifications. For example, in some implementations, the user data table can be implemented using more or fewer columns than those shown in FIG. 1, may combine two or more columns of information, or may have different columns than shown in the illustration.

As shown in FIG. 1, the data processing system also receives public events data 122. The public events data 122 may be received from one or more public data sources 120A-120N that the data analytics platform 100 has subscribed to. Upon subscribing to a particular public data source, the data analytics platform 100 may start receiving a stream of public events data from that particular public data source. Public data sources 120A-120N are generally provided by third party providers. The public events data 122 received from the public data sources 120 do not contain any user information for a user whose data is included in the user data 106. The public events data 122 are not triggered due to or in response to actions or activities performed by the users for whom the user data 106 is collected. In certain embodiments, each event data tuple in a public data stream has the following schema or structure:

Public event schema={(timestamp), (one or more <attribute-value> pairs)) As shown above, each event data tuple has an associated timestamp. The timestamp may represent a time or some number that denotes time information. The timestamps associated with an event data tuple may be set by the public data source that was the source of or that generated that event data tuple. In some embodiments, the timestamp may be set by the computer system 102 and may represent a time when the event data tuple was received by computer system 102. In addition to the timestamp, each event data tuple also includes one or more <attribute-value> pairs. An attribute-value pair identifies an attribute and a value associated with the attribute. The <attribute-value> pairs may be different for different event streams, for example, for public event streams received from different public sources.

Examples of public data sources and public event streams include, without limitation:

(a) A stream of public events data received at periodic intervals from a weather website, each public event stream comprising event data tuples having a timestamp and containing location and weather information specified in the <attribute-values> pairs such as <latitude=value>, <longitude=value>, <temp=value>, <precipitation=value>, <humidity=value>, <wind speed=value>;
(b) A stream of public events data from a stock pricing data source, each event data tuple having a timestamp and containing stocks information specified in the <attribute-values> pairs such as <stockSymbol #1=value>, <stockSymbol #2=value>, etc.

In certain embodiments, the public events manager 118 may include a public events processing subsystem 124, a public events selection 126 subsystem and an alert generation subsystem 128. The public events processing subsystem 124 may be configured to receive public events data (e.g., in the form of public event streams) from the public data sources 120A-120N and process the public events data to determine a public event type and one or more public event categories associated with the public event streams. The public events processing subsystem 124 may determine a public event type and one or more public event categories for a public event stream based on a variety of ways. In one approach, a public event type for a public event stream may be determined based on the attributes of the event data tuples in the public data stream. For example, a public event type for a “weather” event stream may be determined to be “weather-region 1” because the public event stream comprises event data tuples comprising one or more attributes that measure temperature in a specific region (e.g., New York). Based on the public event type, the public events processing subsystem 124 determines a one or more public event categories for the public event stream. The public event categories represent the category of information represented by the public event stream. For example, the “weather” event stream may be associated with public event categories such as “weather” or “rainfall” because the public event stream is associated with weather information.

In another approach, a public event type and a public event category for a public event stream may be determined based on the data source associated with the public event stream. For example, the public event type and the public event category for a “weather” event stream may be determined to be “weather-region 1” and “weather” respectively because the weather event stream originates from a weather website that records weather in a particular region. In yet another approach, the public events processing subsystem 124 may determine a public event type and a public event category for a public event stream based on mapping rules 130. For instance, the mapping rules 130 may include rules to map one or more attributes of the event data tuples in a public event stream to a public event type and rules to map each public event type to one or more public event categories.

In certain embodiments, the processed public events data may be stored in a public event(s) data store 134 associated with the platform 100. In one example, the public event(s) data store 134 may be implemented as a relational database that stores public events data related to the public event streams in one or more tables. An example of a public events data table is shown below:

Public Events Data Table

| Public Data | Public Event | | Event | Event Data |
|---|---|---|---|---|
| Source | Streams | Schema | Data Type | Categories |
| 1 | A | Schema for | T1 | C1, C2 |
| | | stream (A) | | |
| 2 | B | Schema for | T2 | C1, C2, C4 |
| | | stream (B) | | |
| 2 | C | Schema for | T3 | C5, C6 |
| | | stream (C) | | |

The illustrated public event(s) data store 134 is merely an example and is not intended to unduly limit the scope of claimed embodiments. One of ordinary skill in the art would recognize many possible variations, alternatives, and modifications. For example, in some implementations, the public event(s) data store 134 can be implemented using more or fewer columns than those shown in FIG. 1, may combine two or more columns of information, or may have different columns than shown in the illustration.

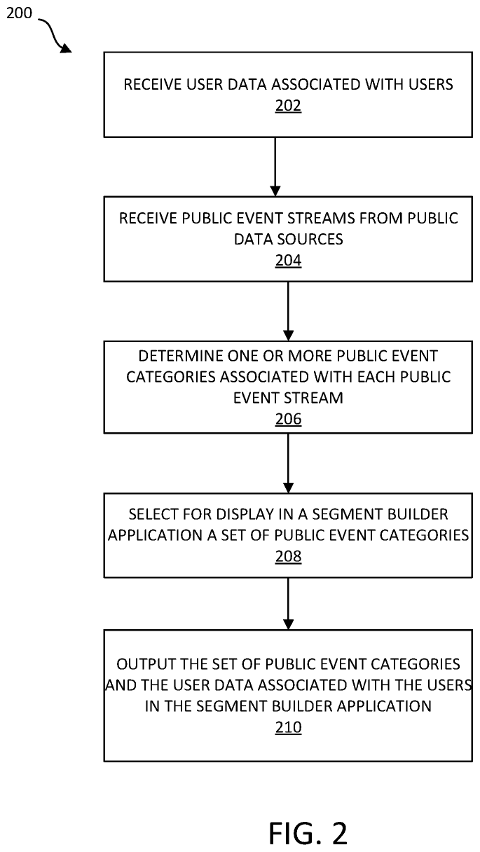

In certain embodiments, the public events selection subsystem 126 is configured to identify and select one or more public event categories and one or more public event types from the public event(s) data store 134 and the alert generation subsystem 128 is configured to output the selected public event categories and the public event types to the segment builder application 112. The public events selection subsystem 126 may utilize a set of rules/correlations 132 to identify and select the public event categories and the public event types. A customer (e.g., user 104) of the segment builder application 112 may utilize the public event categories and the public event types to generate new user segments or to modify existing user segments. The manner in which the public events selection subsystem 126 may identify and select public event categories and public event types to be shown via the segment builder application 112 is discussed in detail in relation to FIG. 2.

A segment builder application 112 enables a user (e.g., a customer 104 of the platform 100) to create user segments. In certain examples, the segment builder application 112 may utilize the user data 106 stored in the user data store 110 to generate one or more user segments. As described above, a “user segment” is used to refer to a group or subset of users and is defined by one or more conditions or criteria associated with the user segment that a user may satisfy to be considered a member of the user segment. In certain embodiments, the user segments may be generated based on user segment expressions provided by a customer 104 of the platform 100 via the segment builder application 112. For example, the customer 104 operating a customer computing device may interact with a segment builder application user interface (UI) 114 of the segment builder application 112 to provide a segment expression by selecting user events, user attributes, rules, public event types, and/or public event categories via the UI 114.

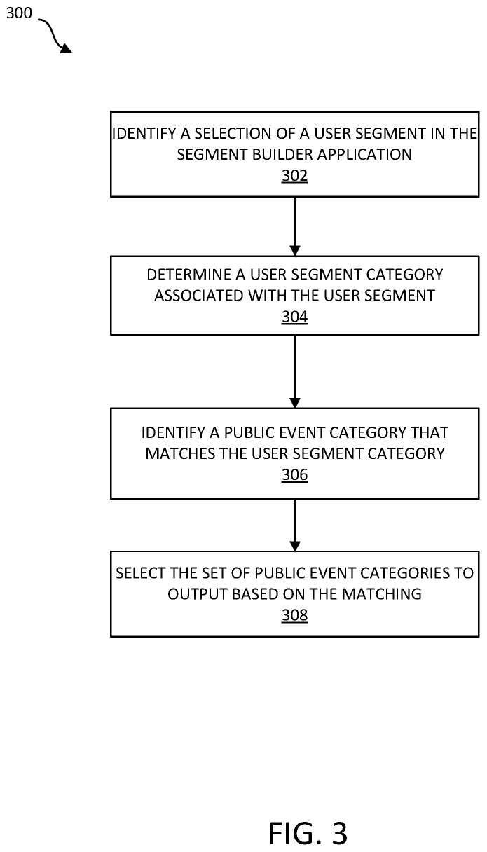

As an example, the user may create, via the UI 114, a segment expression for an “Umbrella Segment” to identify users who purchased an umbrella on the product's website. To create such a segment expression, the user may select a user event (e.g., a purchase event) and a rule related to the user event (item purchased=“Umbrella” and zip code=“95148”) via the UI 114. Additional details of the manner in which a user may interact with the UI 114 to provide a segment expression is discussed in detail in FIG. 3.

In certain embodiments, the segment builder application 112 may generate a user segment based on the segment expression by executing the segment expression against the user data stored in the user data store 110. In one example, the segment expression comprises one or more conditions applied to the user data and one or more conditions applied to the public event types. In one implementation, a segment expression may be represented as an SQL expression that can be queried and executed by the segment builder application 112 against the user data stored in the user data store 110 and the public event data stored in the public events data store to generate a user segment. As an example, an SQL expression for an “Umbrella Segment” generated by the segment builder application 112 is shown below:
SELECT * FROM user data table WHERE UId.User Data=“umbrella” AND UId.purchaseEvent=“Purchase.”

For example, the above select statement identifies a set of users who purchased an umbrella item on the product's website. In one example, the generated user segments may be stored in a user segment(s) data store 116. In certain embodiments, the segment builder application 112 may be configured to associate each user segment stored in the user segment(s) data store 116 with a user segment category. For instance, the segment builder application 112 can associate a “Weather Category” to the “Umbrella Segment” discussed above.

In certain embodiments, the user segments data store 116 may be implemented as a relational database that organizes the user segments in one or more tables. An exemplary illustration of a user segment table is shown below:

User Segment Table

| User Segment | User Segment Category |
|---|---|
| Umbrella | Weather |
| Winter Wear Buyers | Winter/Weather |
| Sports Gear Buyers | Sports |

The illustrated user segment data table is merely an example and is not intended to unduly limit the scope of claimed embodiments. One of ordinary skill in the art would recognize many possible variations, alternatives, and modifications. For example, in some implementations, the user segment table can be implemented using more or fewer columns than those shown in FIG. 1, may combine two or more columns of information, or may have different columns than shown in the illustration.

In certain embodiments, the segment builder application 112 is configured to output the public event types 130 and one or more public event categories associated with the public event types via the segment builder application UI 114. A user (e.g., 104) may select a public event type to view attributes of the event data tuples in the public event stream. For instance, the user may select a “weather” event type and view the attributes of the “weather” event data tuples such as the timestamp of the event data tuple, the recorded temperature, the wind direction, wind speed, precipitation and so on. In certain embodiments, the public event types 130 and the public event categories may be output to the customer 104 along with user events and existing user segments (e.g., generated by the segment builder application 114). The customer 104 may utilize one or more of the selected public event types 130 to generate a new segment expression or to modify an existing segment expression associated with an existing user segment. For instance, continuing with the example of the “Umbrella Segment” described above, the customer 104 may modify the segment expression of the “Umbrella Segment” with a “weather” event type to identify users located in a particular zip code that is going experience an upcoming rain storm. For instance, the customer may add (via the UI) a condition related to one or more event attributes associated with the “weather” event type, e.g., {(weatherEvent.zipcode=“95148”) and (weatherEvent.precipitation>“90”)} to generate a modified user segment expression for the “Umbrella Segment.” As an example, a modified SQL expression for an “Umbrella Segment” that includes a public event type is shown below:
SELECT * FROM user data table WHERE UId.zipcode=weatherEvent.zipcode AND weatherEvent.precipitation>“90”

The segment builder application 112 can then generate a modified user segment based on the user segment expression by executing the user segment expression against the user data stored in the user data store 110 and the public events data stored in the public events data store 134 and store the modified segment in the user segment(s) data store 116.

The system depicted in FIG. 1 can address several deficiencies of conventional user segmentation techniques. For instance, existing data analysis tools for generating user segments are limited to facilitating creation of user segments using criteria or attributes present in the user data captured for users. The automated data analysis techniques described in the present disclosure improve upon these existing data analysis tools by enabling user segments to be generated based upon attributes of user data and additionally based on public event streams accessible via public networks. By enabling user segments to be generated based upon the public data, the data analytics platform or tool described in this disclosure enables user segments to be created that can be used to customize content based on a combination of both historical user data and real-time, transient event data (e.g., weather forecasts). Additionally, the data analytics platform disclosed herein can automatically provide suggestions for modifying existing user segments based upon the public event streams to generate improved user segments that are better customized based upon the public events data (e.g., by automatically suggesting criteria, based upon user data and the public data, for creating new user segments or modifying existing user segments). The modified or new user segments can then be used to more intelligently target customized content to users of the segments.

Additionally, the disclosed data analytics platform provides capabilities for storing and processing large volumes of data and efficiently querying time series data associated with public event streams towards the generation of user segments. The platform or tool provides the ability to connect to and classify public event feeds, build machine learning algorithms that match pre-existing segments to types of public event feeds and enhance the algorithms by measuring feedback from the users' attitude towards the matches, thereby resulting in the generation of enhanced user segments.

Embodiment Describing Additional Operations Performed by the Data Analytics Platform (and its Components) to Identify and Select Public Event Categories and Public Event Types for Defining and Creating User Segments Using the Segment Builder Application.

The operations performed by the data analytics platform to identify and select public event categories and public event types for defining and creating user segments using the segment builder application are now described with reference to FIGS. 2-4. FIG. 2 depicts an example of a process 200 for identifying and selecting one or more public event types and public event categories to output to a user (e.g., 104) of the platform 100 according to certain embodiments. One or more computing devices (e.g., the public events manager 118 of the computer system 102) implement operations depicted in FIG. 2 by executing suitable program code. For illustrative purposes, the process 200 is described with reference to certain examples depicted in the figures. Other implementations, however, are possible.

The processing depicted in FIG. 2 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 200 presented in FIG. 2 and described below is intended to be illustrative and non-limiting. Although FIG. 2 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIG. 2, the processing depicted in blocks 202-208 in FIG. 2 are performed by the public events processing subsystem 124, the public events selection subsystem 126 and the alert generation subsystem 128 of the public events manager 118 depicted in FIG. 1 or other aspects of the public event(s) manager 118.

At block 202, the process 200 involves receiving user data associated with users. As noted above, the user data includes user attributes and values associated with the user attributes. The user data is generated by interactions with online content by user devices. The user data may include user interactions and values associated with the user interactions. For example, for a user interacting with a website, the user attributes and associated values may include name of the user, age of the user, location of the user, gender of the user, preferences of the user, and the like. The user interactions may include webpages or website links accessed by the user, actions taken by the user on a web page (e.g., a purchase of an item), products/services purchased by the user using the website, value of the purchases, clicks, products added to a virtual shopping cart, browsing information, and so on.

At 204, the process 200 involves receiving one or more public event streams from one or more public data sources. As discussed in relation to FIG. 1, the public data sources (e.g., 120A-120N) may include external/remote data sources (that are not associated with user data associated with users) that a customer (e.g., a user 104) of the platform 100 can identify or subscribe to. For instance, the external data sources may include a weather source, a news source, a stock information source and so on. The public event streams may include, for instance, a weather event stream received from a weather data source, a stock event stream received from a stock data source, a news event stream received from a news data source and so on.

At block 206, the process 200 involves determining a public event type and one or more public event categories associated with each public event stream. In one example, a public event type and a public event category for a public event may be determined based on the attributes associated with the event data tuples in the public event stream. For example, a public event type for a “weather” event may be determined to be “weather-region 1” because the event data tuples of the public event stream comprise attributes that measure temperature in a specific region (e.g., New York). The public event categories for the “weather” event stream may be determined to be “weather” or “rainfall” because the event data tuples are associated with weather information. In another approach, a public event type and a public event category for a public event stream may be determined based on the data source associated with the public event stream. For example, the public event type and the public event category for a “weather” event stream may be determined to be “weather-region 1” and “weather” respectively because the “weather” event stream originates from a weather website that records weather in a particular region. In yet another approach, a public event type and a public event category for a public event stream may be determined based on mapping rules 130 that comprise rules to map one or more attributes of the event data tuples in a public event stream to a public event type and rules to map each public event type to one or more public event categories. In certain examples, and as discussed in relation to FIG. 1, information (e.g., event attributes) related to the public events along with their event types and event categories may be stored in a public event(s) data store (e.g., 134) of the computer system 102.

At block 208, the process 200 involves selecting a set of public event categories (e.g., from the public event categories stored in the public event(s) data store 134) for display in the segment builder application 112. In certain examples, the selection of the public event categories may be performed by the public events selection subsystem 126. The selection of the public event categories may be performed in a variety of ways. In one example, the public events selection subsystem 126 may receive input from a customer (e.g., user 104) of the platform 100 indicating one or more public event categories and the public events selection subsystem 126 may select the public event categories to output based on the user input. For instance, the customer may provide the input via the UI 114 of the segment builder application 112. In another example, the public events selection subsystem 126 may receive input from the customer indicating a public data source associated with a public event stream and the public events selection subsystem 126 may select the public event categories based on the data source. In another example, the public events selection subsystem 126 may select public event categories based on identifying the customer's interaction with a particular user segment in the segment builder application 112. Additional details of the manner in which the public events selection subsystem 126 may select a public event category based on identifying a user's interaction with a user segment is described with reference to FIG. 3.

At block 210, the process involves outputting the set of public event categories along with the user data via a UI (e.g., 114) of the segment builder application 112. In certain embodiments, the user 104 may utilize the public event categories and the user data to generate an expression for a new user segment or to modify an existing user segment expression. As discussed in relation to FIG. 1, the segment builder application 112 may then execute the user segment expression against the data stores (110, 134) to generate a new user segment or a modified user segment.

FIG. 3 depicts an example of a process 300 for selecting public event categories and public event types to output to a customer of the platform 100 according to certain embodiments. In certain embodiments, such as in the embodiment depicted in FIG. 3, the processing depicted in blocks 302-308 are performed by an integration algorithm in the public events selection subsystem 126 of the public events manager 118 depicted in FIG. 1. At block 302, the process 300 involves identifying a selection of a user segment in the UI 114 of the segment builder application 112 by a user 104 of the segment builder application. For instance, the process at block 302 may involve identifying that the user 104 has selected an “Umbrella Segment” via the UI 114.

At block 304, the process 300 involves determining a user segment category associated with the user segment. For example, the public events selection subsystem 126 may determine the user segment category based on the information stored in the user segment(s) data store 116 (shown in FIG. 1). For instance, the “Umbrella Segment” may be associated with a “Weather” user segment category.

At block 306, the process 300 involves identifying a public event category that matches the user segment category of the selected user segment. In certain embodiments, the public events selection subsystem 126 may identify a public event category matching the user segment category of the selected user segment based on a set of rules/criteria 132 (shown in FIG. 1). For instance, the rules/criteria 132 may include one or more association rules (e.g., in the form of if-then-else rules) that map user segment categories associated with user segments to public event categories associated with public event streams. An example of an association rule is shown below:

If (user segment category=“weather”) and (Public Event Category=“weather”) then correlate user segment category to public event category.

In another approach, the public events selection subsystem 126 may identify a public event category matching the user segment category of the selected user segment by obtaining a set of historical data comprising past correlations of user segment categories to public event categories. In yet another approach, the public events selection module 126 may identify a public event category matching the user segment category of the selected user segment based on input received from a machine learning model. In some instances, a supervised machine learning model may be employed that uses training data comprising user data (user attributes and user interactions), public event types, public event categories and marketer interactions with the system. For example, the supervised machine learning model may use the training data to cluster user data that are more similar (in one or more respects) to each other than to those in other groups and/or clusters and suggest a public event type and one or more public event categories related to each user data group. In other instances, other types of machine learning models may be employed such as unsupervised machine learning, vector representation, using labeled classifiers and/or some combination thereof.

At block 308, the process involves selecting the set of one or more public event categories to output based on the matching. In some examples, the process at 308 may involve transmitting the selected public event categories and one or more public event types associated with the public event categories to the alert generation subsystem for 128 which may then output the selected public event categories and public event types to the segment builder application 112.

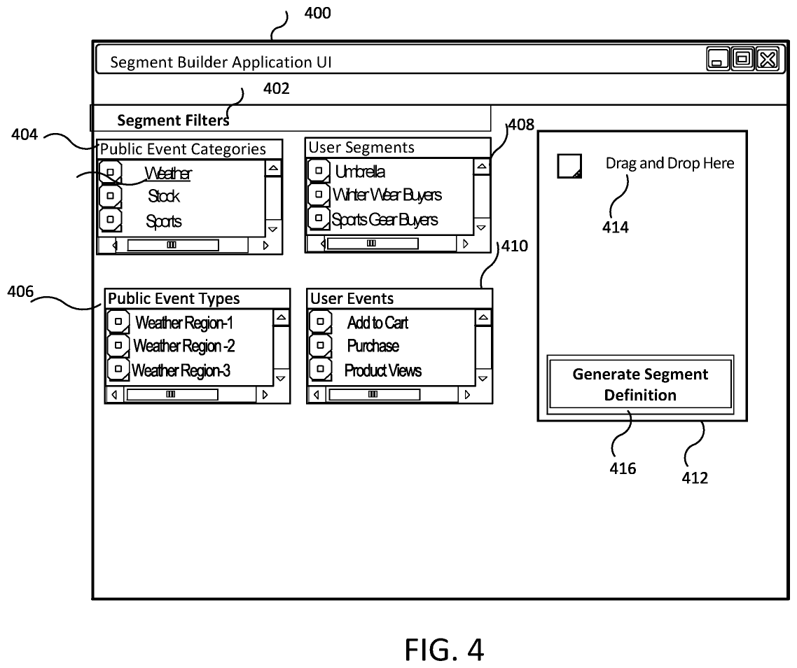

FIG. 4 is an example of a user interface (UI) that may be utilized to create user segment expressions, according to some embodiments. In one example, the UI 400 is an example of a segment-definition interface in a segment builder application (e.g., 112) shown in FIG. 1. In certain embodiments, the segment builder application UI 400 provides functionality for displaying one or more segment filters (or components) 402 such as public event categories 404, public event types 406, user segments 408 and user events 410 for inclusion in the definition and/or generation of user segment expressions. The segment builder application UI 400 provides functionality for providing the segment filters 402 as rules/conditions in an expression for a segment definition, functionality for displaying a canvas for defining segment definitions, receiving input for modifying segment definitions, displaying modified segment definitions, saving segment definitions, clearing the canvas, applying the segment definitions to stored data and so on.

In the exemplary illustration shown in FIG. 4, the segment builder application UI 402 includes a window 412 that includes a canvas for building or creating an expression for a user segment. The window 412 provides an area for drag-and-drop functionality 414 in which segment filters such as public event categories 404, public event types 406, user segments 408 and user events 410 and conditions/rules related to the segment filters (404, 406, 408, 410) can be placed on the canvas to build and/or create an expression for a new user segment or to modify an expression for an existing user segment. In certain examples, a user 104 of the platform 100 may utilize the UI 400 to select the segment filters (404, 406, 408, 410) to generate a new user segment expression or to modify an existing user segment expression.

In certain embodiments, the segment-definition interface (e.g., the UI 400) of the segment builder application receives a recommendation request from a user that identifies a public event stream for integration with the user data. In response to the recommendation request, the segment builder application executes an integration algorithm configured for correlating attributes from the user data with attributes of the public event stream. The segment builder application selects a public event stream that is correlated with one or more of the attributes from the user data and updates the segment-definition interface with a recommendation identifying a set of attributes from the public event stream having a correlation with the attributes from the user data.

In certain embodiments, the segment builder application receives a command from the user to generate or modify a target user segment with the public event stream and the set of attributes from the public event stream. The segment builder application updates the target user segment to integrate data from the public event stream having the set of attributes. In certain examples, the segment builder application causes customized online content associated with the target user segment to be presented to a target user device. The customized online content can include, for instance, customized web pages, specific online content such as targeted campaigns for specific products, etc. to users in the target user segment.

As an example, the user may select a “weather” event stream using the UI 400. Then, the user may select a “weather” event category corresponding to the “weather” event stream from the public event categories 404. The user is then shown a set of public event types 406 (Weather Region-1, Weather Region-2, Weather Region-3) related to the “weather” event category. The user may then modify a segment expression for the “Umbrella Segment” via the UI 400 to include information related to the public event type (e.g., a “Weather Region-1”) associated with the “weather” event category. To modify such a segment definition, the user may select the public event type and access attributes of the event data stream related to the public event type. The user may then add one or more conditions/rules (via the UI) related to one or more event attributes associated with the public event type, e.g., {(weatherEvent.zipcode=95148) and (weatherEvent.precipitation>90)} to the existing user segment expression. The customer may then save the modified user segment expression for the “Umbrella Segment” by selecting the “Generate Segment Definition” button 416 in the window 412. The segment builder application 112 can then generate a modified user segment based on the segment expression by executing the segment expression against data stored in one or more data stores (user data store 110, public events data store 134) and store the modified user segment in the user segment(s) data store 116.

Embodiment Describing Operations Performed by the Data Analytics Platform for Recommending Ways for Enhancing a Previously Defined User Segment Using Certain Selected Public Event Categories and Public Event Types

In accordance with another set of embodiments, the data analytics platform may be configured to enhance a previously defined user segment (e.g., a user segment previously defined using criteria based upon user data attributes) using certain selected public event categories and public event types. FIG. 5 depicts an example of a process 500 for enhancing a previously defined user segment using certain selected public event categories and public event types according to certain embodiments. One or more computing modules (e.g., the public events manager 118 of the platform 100) implement operations depicted in FIG. 5 by executing suitable program code. For illustrative purposes, the process 500 is described with reference to certain examples depicted in the figures. Other implementations, however, are possible.

The processing depicted in FIG. 5 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 500 presented in FIG. 5 and described below is intended to be illustrative and non-limiting. Although FIG. 5 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIG. 5, the processing depicted in blocks 502-510 in FIG. 5 are performed by the public events selection subsystem 126 and the alert generation subsystem 128 of the public events manager 118 depicted in FIG. 1 or other aspects of the public event(s) manager 118.

At 502, the process 500 involves receiving one or more public event streams from one or more public data sources. As discussed above, the public data sources (e.g., 120A-120N) may include external data sources (that are not associated with user data associated with users) that a customer (e.g., a user 104) of the platform 100 can identify or subscribe to. For instance, the external data sources may include a weather source, a news source, a stock information source and so on. The public event streams may include, for instance, a weather event stream received from a weather data source, a stock event stream (e.g., comprising changes in price to a stock symbol) received from a stock data source, a news event stream received from a news data source and so on.

At block 504, the process 500 involves determining one or more public event categories associated with each public event stream. As noted above, the public event categories associated with a public event stream may be determined based on attributes associated with the event data tuples in the public event stream, a data source associated with the public event stream or based on mapping rules that associate one or more attributes of the event data tuples to a public event category associated with the public event stream.

At block 506, the process 500 involves receiving information related to a user segment. In some examples, the information related to a user segment may be stored in a user segment(s) data store 116 of the platform 100. As noted above, information related to a user segment may comprise an expression that includes one or more conditions applied to the user data (e.g., user attributes, user events, user interactions) associated with the users. In one implementation, a user segment may be represented as an SQL expression that can be queried and executed by the segment builder application 112 against the user data stored in the user data store 110. As an example, an SQL expression for a “Winter Wear Buyers” segment generated by the segment builder application 112 is shown below:
SELECT * FROM user data table WHERE UId.prodname like “% Winter Jacket %” and UId. Int1=“purchase event”;

The above select statement identifies a set of users who purchased a winter jacket on the company's website.

At block 508, the process 500 involves identifying that a user segment category associated with the user segment matches a public event category associated with a public event. For example, a user segment category may be identified based on the information stored in the user segment(s) data store 116 (shown in FIG. 1). For instance, the “Winter Wear Buyers” segment may be associated with a “Winter” category.

In certain examples, the operations performed at block 508 may involve correlating the user segment category to the public event category based on a set of rules/criteria 132 (shown in FIG. 1). For example, the rules/criteria 132 may include association rules (e.g., in the form of if-then-else rules) that map the user segment category associated with the user segment to a public event category associated with a public event stream. In other examples, the operations performed at block 508 may involve obtaining a set of historical data comprising correlations of user segment categories to public event categories. In some other examples, the operations performed at block 508 may involve identifying that the user segment category matches a public event category based on input received from a machine learning model. Continuing with the example of the “Winter Wear Buyers” segment discussed above, the process at block 508 may involve determining that the user segment category (“Winter”) of the Winter Wear Buyers” matches a public event category (“Weather/Winter”) of a “weather” event stream.

At block 510, the process involves outputting information identifying the user segment, information identifying the public event category associated with the public event stream and information identifying a correlation between the user segment and the public event category. In one example, the information may be output as an alert (e.g., as an SMS, an email notification, a voice message and the like) to a customer (e.g., user 104) of the platform 100. In another example, the alert may be output via the segment builder application UI 114, for instance, when the user is interacting with one or more user segments via the UI. FIG. 6 is an example of the information that is output as an alert to a customer of the platform 100, according to some embodiments.

FIG. 6 is an example of an alert that is output to a customer of the platform 100, according to some embodiments. The illustration shown in FIG. 6 is an example of an alert 602 that is transmitted to a customer (e.g., user 104) of the platform 100 when the customer is interacting with one or more user segments via a segment builder UI 600 of the segment builder application. In one example, the UI 600 is an example of a segment-definition interface in a segment builder application (e.g., 112) shown in FIG. 1. In other examples, the alert 602 may be transmitted to the customer (e.g., user 104) of the platform when the customer is not interacting with the segment builder application. For instance, the alert 602 can be sent to the customer such as via an SMS, an email notification, a voice message and the like.

In certain examples, the alert 602 includes information identifying the user segment, information identifying the public event category associated with the public event stream and information identifying a correlation between the user segment and the public event category. For example, the alert 602 includes information identifying the “Winter Wear Buyers” user segment, a “weather” event category associated with a weather event stream, and information identifying a correlation between the “Winter Wear Buyers” user segment and the “weather” event category. Such an alert 602 may include, for example the following information: “You have an existing user segment related to users who buy winter wear, there is an upcoming snow storm in Utah, would you like to enhance the “Winter Wear Buyers” segment to include information related to the upcoming snow storm.” In certain embodiments, the segment builder application may receive an indication (e.g., when the user selects the “Yes” button 604 via the UI) from the customer to generate a modified/enhanced user segment based on the weather event stream. The segment builder application may then generate the modified user segment by adding a condition related to the attributes of the weather event stream into the segment expression associated with the user segment to generate a modified user segment. As an example, the segment builder application may generate an enhanced/modified user segment for the “Winter Wear Buyers” user segment to identify a set of users who are more likely to purchase a winter jacket in a zip code (e.g., Utah) that is going to experience an upcoming snow storm. An example of a modified SQL expression that incorporates attributes of a weather event type (e.g., weather in a particular region) is shown below:
SELECT * FROM user data table WHERE UId.prodname like “% Winter Jacket %” AND UId. Int1=“purchase event” AND UId.zipcode=weatherEvent.zipcode AND weatherEvent.snow=TRUE AND withinDays(5, weatherEvent.timestamp);

The segment builder application can then generate the modified/enhanced user segment based on the modified SQL expression by executing it against the user data stored in the user data store 110 and the public events data stored in the public events data store 134 and store the modified SQL expression in the user segment(s) data store 116.

Embodiment Describing Operations Performed by the Data Analytics Platform for Recommending Ways for Creating a New Focused User Segment Based Upon Attributes Related to Public Event Categories and Public Event Types and Attributes from the User Data.

FIG. 7 depicts an example of a process 700 for creating a new user segment according to certain embodiments. One or more computing modules (e.g., the public events manager 118 of the platform 100) implement operations depicted in FIG. 7 by executing suitable program code. For illustrative purposes, the process 700 is described with reference to certain examples depicted in the figures. Other implementations, however, are possible. The processing depicted in FIG. 7 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 700 presented in FIG. 7 and described below is intended to be illustrative and non-limiting. Although FIG. 7 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIG. 7, the processing depicted in blocks 702-712 in FIG. 7 are performed by the public events selection subsystem 126 and the alert generation subsystem 128 of the public events manager 118 depicted in FIG. 1 or other aspects of the public event(s) manager 118.

At block 702, the process 700 involves obtaining user data associated with users. As noted above, the user data may be generated by interactions with online content by a user device. The user data may include user attributes and values associated with the user attributes. The user data may also include user interactions and values associated with the user interactions.

At 704, the process 700 involves receiving one or more public event streams from one or more public data sources. As discussed above, the public data sources (e.g., 120A-120N) may include external data sources (that are not associated with user data associated with users) that a customer (e.g., a user 104) of the platform 100 can identify or subscribe to. For instance, the external data sources may include a weather source, a news source, a stock information source and so on. The public event streams may include, for instance, a weather event stream received from a weather data source, a stock event stream received from a stock data source, a news event stream received from a news data source and so on.

At block 706, the process 700 involves determining one or more public event categories associated with each public event stream. As noted above, the public event categories associated with a public event stream may be determined based on attributes associated with the event data tuples of the public event stream, a data source associated with the public event stream or based on mapping rules that that associate one or more attributes of the public event stream to a public event category associated with the public event stream.

At block 708, the process 700 involves identifying that a public event category associated with a public event stream matches a user data category associated with the user data. The process at block 708 may further include matching the public event category with the user data category. For example, a user data category associated with the user data may be identified based on a combination of one or more attributes associated with the user data stored in the user data store 110 (shown in FIG. 1).

In certain examples, the operations performed at block 708 may involve correlating the public event category and the user data category based on a set of rules/criteria 132 (shown in FIG. 1). For example, the rules/criteria 132 may include association rules (e.g., in the form of if-then-else rules) that map a public event category associated with a public event stream to a user data category associated with the user data. In other examples, the operations performed at block 508 may involve obtaining a set of historical data comprising past correlations of user data categories to public event categories. In some other examples, the operations performed at block 508 may involve identifying that a public event category matches a user data category based on input received from a machine learning model.

At block 710, the process 700 involves identifying an expression for defining a new user segment. In some examples, the expression may include a first condition based on an attribute of a public event type associated with the public event category and a second condition based on a user attribute associated with the user data.

At block 712, the process 700 involves outputting information related to the new segment. In one example, the alert may be output to the customer via an SMS, an email notification, a voice message and the like. In certain embodiments, the operations performed at blocks 710 and 712 may further include obtaining input selecting a public event category and the one or more user attributes (via the segment builder application) and creating the new user segment based upon the selected public event category and the one or more user attributes. The operations may further include causing customized online content associated with the user segment to be presented to the user device. The customized online content can include, for instance, customized web pages, specific online content such as targeted campaigns for specific products, etc. to users in that user segment. In certain examples, the customized online content is a web page with a layout, functionality, or both tailored to the characteristics of a given user segment and the characteristics of the public data used to augment the user segment. FIG. 8 is an example of an alert that is output to a customer of the platform 100, according to some embodiments.

FIG. 8 is an example of an alert that is output to a customer of the platform 100, according to some embodiments. In certain examples, the alert 800 can be sent to the customer via an SMS, an email notification, a voice message and the like. In certain examples, the alert the 800 includes information about a new user segment. For example, the alert 800 includes the following information about a new segment: “Summer is coming up. May I suggest a new segment to market your swimwear?” In certain embodiments, a user-selectable parameter may be provided that a user can set as to whether the data analytics platform is allowed to automatically create new segments. In such embodiments, and when this parameter is set, then in addition to suggestions, in some instances, the data analytics platform may also automatically generate the new segment.

As an example, the segment builder application may generate a new user segment “Swimwear Buyers” to identify a set of users who are likely to purchase swimwear on the company's website. An example of an SQL expression for the “Swimwear Buyers” segment that incorporates attributes of a weather event type (e.g., weather in a particular region) is shown below:
SELECT * FROM user data table WHERE UId.prodcategory like “% swimwear %” AND UId.zipcode=weatherEvent.zipcode AND weatherEvent.temperature>80;

The segment builder application may then execute the SQL expression for defining the new user segment against the user data stored in the user data store 110 and the public events data stored in the public events data store 134 and store the new SQL expression in the user segment(s) data store 116.

Examples of a Computing Environment for Implementing Certain Embodiments

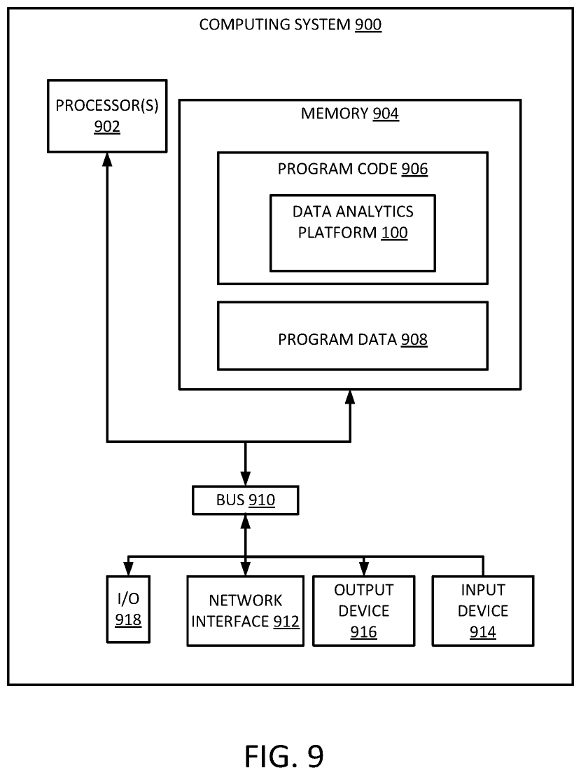

Any suitable computing system or group of computing systems can be used for performing the operations described herein. For example, FIG. 9 depicts an example of a computing system 900 usable for implementing the data analytics platform 100 in FIG. 1. In an embodiment, a single computing system 900 having devices similar to those depicted in FIG. 9 (e.g., a processor, a memory, etc.) combines the one or more operations and data stores depicted as separate subsystems in FIG. 1.

The depicted example of the computing system 900 includes a processor 902 communicatively coupled to one or more memory devices 904. The processor 902 executes computer-executable program code stored in a memory device 904, accesses information stored in the memory device 904, or both. Examples of the processor 902 include a microprocessor, an application-specific integrated circuit (“ASIC”), a field-programmable gate array (“FPGA”), or any other suitable processing device. The processor 902 can include any number of processing devices, including a single processing device.

The memory device 904 includes any suitable non-transitory computer-readable medium for storing program code 906, program data 908, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, and JavaScript. In various examples, the memory device 1104 can be volatile memory, non-volatile memory, or a combination thereof.

The computing system 900 executes program code 906 that configures the processor 902 to perform one or more of the operations described herein. Examples of the program code 906 include, in various embodiments, program code implementing functionality associated with the data analytics platform 100 or any other suitable systems or subsystems that perform one or more operations described herein. The program code 906 may be resident in the memory device 904 or any suitable computer-readable medium and may be executed by the processor 902 or any other suitable processor.

The processor 902 is an integrated circuit device that can execute the program code 906. The program code 906 can be for executing an operating system, an application system or subsystem (e.g. data analytics platform 100), or both. When executed by the processor 902, the instructions cause the processor 902 to perform operations of the program code 906. When being executed by the processor 902, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In certain embodiments, the program data 908 includes user data (e.g., stored in the user data store 110), information related to public events (e.g., stored in the public events data store 134) and user segment information (e.g., stored in the user segments data store) for generating and/or modifying user segments.

In certain embodiments, the program code 906 and/or the program data 908 are distributed across multiple memory devices 904 that are accessible via a data network. One or more buses 910 are also included in the computing system 900. The buses 910 communicatively couple components of the computing system 900 to each other and/or to external components.

In certain embodiments, the computing system 900 includes a network interface device 912. The network interface device 912 includes any device or group of devices suitable for establishing a wired or wireless data connection to one or more data networks. Non-limiting examples of the network interface device 912 include an Ethernet network adapter, a modem, and/or the like. The computing system 900 is able to communicate with one or more other computing devices (e.g., a computing device performing a downstream operating on a unicode generated by computing system 900) via a data network using the network interface device 912.

The computing system 900 may also include a number of external or internal devices, an input device 914, an output device 916, or other input or output devices. For example, the computing system 900 is shown with one or more input/output (“I/O”) interfaces 918. An I/O interface 918 can receive input from input devices or provide output to output devices. An input device 914 can include any device or group of devices suitable for receiving visual, auditory, or other suitable input that controls or affects the operations of the processor 902. Non-limiting examples of the input device 914 include a touchscreen, a mouse, a keyboard, a microphone, a separate mobile computing device, etc. An output device 916 can include any device or group of devices suitable for providing visual, auditory, or other suitable sensory output. Non-limiting examples of the output device 916 include a touchscreen, a monitor, a speaker, a separate mobile computing device, etc.

Although FIG. 9 depicts the input device 914 and the output device 916 as being local to the computing system, other implementations are possible. For instance, in some embodiments, one or more of the input device 914 and the output device 916 can include a remote client-computing device that communicates with the computing system 900 via the network interface device 912 using one or more data networks described herein.

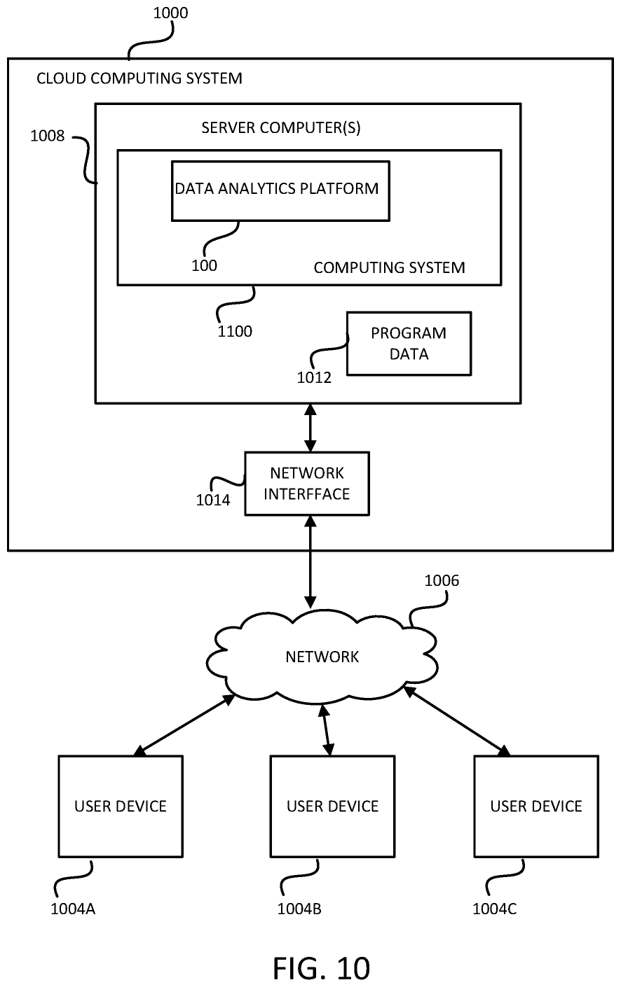

In some embodiments, the functionality provided by the computing system 900 may be offered as cloud services by a cloud service provider. For example, FIG. 10 depicts an example of a cloud computing system 1000 offering one or more segment building services that can be used by a number of subscribers using user devices 1004A, 1004B, and 1004C across a network 1006. In certain embodiments, the segment building services provided by cloud computing system 1000 include a service that generates new or modified user segments by combining user data and information about public events supplied by the user devices 1004A to 1004C. In some cases, the segment building services may be offered under a Software as a Service (SaaS) model. One or more users may subscribe to the segment building services, and the cloud computing system performs the processing to provide the segment building services to subscribers. The cloud computing system 1000 may include one or more remote server computers 1008.

The remote server computers 1008 include any suitable non-transitory computer-readable medium for storing program code (e.g., code for the data analytics platform 100), program data 1012, or both, which is used by the cloud computing system 1000 for providing the cloud services. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the server computers 1008 can include volatile memory, non-volatile memory, or a combination thereof.

One or more of the servers 1008 execute the program code 1010 that configures one or more processors of the server computers 1008 to perform one or more of the operations that provide segment building services, such as generating new or modified user segments by combining user data and information about public events. Any other suitable systems or subsystems that perform one or more operations described herein (e.g., a UI subsystem for receiving segment definitions) can also be implemented by the cloud computing system 1000.

In certain embodiments, the cloud computing system 1000 may implement the services by executing program code and/or using program data 1012, which may be resident in a memory device of the server computers 1008 or any suitable computer-readable medium and may be executed by the processors of the server computers 1008 or any other suitable processor. In certain embodiments, the program data 1012 includes any of the data described in connection with program data 1108. The program data 1012 is stored on the same memory device or distributed across different memory devices accessible via the network 1006.

The cloud computing system 1000 also includes a network interface device 1014 that enables communications to and from cloud computing system 1000. In certain embodiments, the network interface device 1014 includes any device or group of devices suitable for establishing a wired or wireless data connection to the network 1006. Non-limiting examples of the network interface device 1014 include an Ethernet network adapter, a modem, and/or the like. The computing system 1000 is able to communicate with the user devices 1004A to 1004C via the network 1006 using the network interface device 1014.

General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method comprising:
accessing, with a segment builder application, user data generated by interactions with online content by user devices and a set of public event streams accessible from remote data sources, each public event stream describing one or more events independent of the interactions with the online content;
receiving, via a segment-definition interface of the segment builder application, a recommendation request for identifying public event stream data for integration with the user data;
responsive to receiving the recommendation request:
executing an integration algorithm configured for correlating attributes from the user data with attributes of the public event stream,
selecting, via the integration algorithm, a public event stream that is correlated with one or more of the attributes from the user data, and
updating the segment-definition interface with a recommendation identifying a set of attributes from the public event stream having a correlation with the one or more of the attributes from the user data;
receiving, via the segment-definition interface, a command to generate or modify a target user segment with the public event stream and the set of attributes from the public event stream; and
updating, with the segment builder application and responsive to the command, the target user segment to integrate data from the public event stream having the set of attributes, wherein updating the target user segment causes customized online content associated with the target user segment to be presented to a target user device.

2. The method of claim 1, further comprising determining, by the computer system, a public event category associated with the public event stream, the public event category determined based on:
the attributes of the public event stream;
a data source associated with the public event stream; or
a set of mapping rules that map the attributes of the public event stream to a public event type associated with the public event stream.

3. The method of claim 1, further comprising selecting, by the computer system, a public event category associated with the public event stream for display via the segment-definition interface of the segment builder application based on:
receiving input indicating the public event category; and
selecting the public event category based on the input.

4. The method of claim 1, further comprising selecting, by the computer system, a public event category associated with the public event stream for display via the segment-definition interface of the segment builder application based on:
receiving input indicating a public data source associated with the public event stream; and
selecting the public event category based on the public data source.

5. The method of claim 1, further comprising selecting, by the computer system, a public event category associated with the public event stream for display via the segment-definition interface of the segment builder application based on identifying a selection of one or more user segments in the segment builder application.

6. The method of claim 1, wherein selecting, via the integration algorithm, the public event stream that is correlated with the attributes from the user data comprises correlating a public event category associated with the public event stream to a user data category associated with the user data using a set of association rules.

7. The method of claim 1, wherein selecting, via the integration algorithm, the public event stream that is correlated with the attributes from the user data is based on input received from a machine learning model.

8. The method of claim 1, further comprising:
determining, by the computer system, a public event type for the public event stream based the attributes associated with the public event stream; and
outputting, by the computer system, in the segment builder application, the public event type for the public event stream.

9. The method of claim 1, wherein updating the target user segment to integrate data from the public event stream comprises:
obtaining, via the segment-definition interface, a condition related to a public event type associated with the public event stream;
adding, via the segment-definition interface, the condition related to the public event type and the user attributes into an expression of the target user segment; and
executing, by the segment builder application, the expression to generate the target user segment.

10. A non-transitory computer-readable medium having program code that is stored thereon, the program code executable by one or more processing devices for performing operations comprising:
obtaining one or more public event streams from one or more public data sources;
determining one or more public event categories associated with the one or more public event streams;
obtaining information related to a user segment, the information comprising an expression comprising one or more conditions based on one or more user attributes of user data associated with one or more users;
identifying that a user segment category associated with the user segment matches a public event category associated with a public event stream of the one or more public event streams;
based on the identifying, outputting information identifying the user segment, information identifying the public event category associated with the public event stream and information identifying a correlation between the user segment and the public event category;
obtaining, by the computer system, a selection of the public event category and the one or more user attributes;
creating, by the computer system, a modified user segment based upon the selected public event category and the one or more user attributes; and
causing, by the computer system, customized online content associated with the modified user segment to be presented to a user device.

11. The non-transitory computer-readable medium of claim 10, wherein the operations further comprise: outputting the information identifying the user segment, the information identifying the public event category associated with the public event stream and the information identifying a correlation between the user segment and the public event category as a short text message (SMS), an email alert, or a voice message to a user of the computer system.

12. The non-transitory computer-readable medium of claim 10, wherein the operations further comprise: outputting the information identifying the user segment, the information identifying the public event category associated with the public event stream and the information identifying a correlation between the user segment and the public event category in a segment builder application used for creating user segments associated with the users.

13. The non-transitory computer-readable medium of claim 10, wherein the operations for creating the modified user segment further comprise:
identifying a public event type associated with the selected public event category;
adding a condition related to the public event type associated with the public event category into an expression associated with the modified user segment;
executing the expression to generate the modified user segment; and
storing the modified user segment.

14. The non-transitory computer-readable medium of claim 13, wherein the modified user segment combines the condition related to the public event type and a condition related to the one or more user attributes of the user data associated with the users.

15. The non-transitory computer-readable medium of claim 10, wherein the operations for identifying that the user segment category matches the public event category comprises correlating the user segment category to the public event category using a set of association rules.

16. A system comprising:
a memory storing user data generated by interactions with online content by user devices; and
one or more processors configured to execute a segment builder application and thereby perform operations comprising:
accessing a set of public event streams accessible from remote data sources, each public event stream describing one or more events independent of the interactions with the online content,
receiving, via a segment-definition interface of the segment builder application, a recommendation request for identifying public event stream data for integration with the user data,
selecting, with an integration algorithm for correlating attributes from the user data with attributes of the public event stream, a public event stream that is correlated with one or more of the attributes from the user data,
updating the segment-definition interface with a recommendation identifying a set of attributes from the public event stream having a correlation with the one or more of the attributes from the user data,
receiving, via the segment-definition interface, a command to generate or modify a target user segment with the public event stream and the set of attributes from the public event stream, and
updating, with the segment builder application and responsive to the command, the target user segment to integrate data from the public event stream having the set of attributes.

17. The system of claim 16, the operations further comprising selecting a public event category associated with the public event stream for display via the segment-definition interface of the segment builder application based on identifying a selection of one or more user segments in the segment builder application.

18. The system of claim 16, wherein selecting, via the integration algorithm, the public event stream that is correlated with the attributes from the user data comprises correlating a public event category associated with the public event stream to a user data category associated with the user data using a set of association rules.

19. The system of claim 16, wherein selecting, via the integration algorithm, the public event stream that is correlated with the attributes from the user data is based on input received from a machine learning model.

20. The system of claim 16, wherein updating the target user segment to integrate data from the public event stream comprises:
obtaining, via the segment-definition interface, a condition related to a public event type associated with the public event stream;
adding, via the segment-definition interface, the condition related to the public event type and the user attributes into an expression of the target user segment; and
executing, by the segment builder application, the expression to generate the target user segment.
